(19) United States
(12) Patent Application Publication
(10) Pub. No.: US 2015/0194083 A1
(43) Pub. Date: Jul. 9, 2015

(54) ADAPTIVE POWER-EFFICIENT HIGH-SPEED DATA LINK BETWEEN DISPLAY CONTROLLER AND COMPONENT ON GLASS DRIVER ICS

(71) Applicant: Pixtronix, Inc., San Diego, CA (US)

(72) Inventors: Pavel Sinha, San Diego, CA (US); Paul Penchin Pan, San Diego, CA (US); Alain Blaing Nadiguebe, La Jolla, CA (US)

(21) Appl. No.: 14/542,073

(22) Filed: Nov. 14, 2014

Related U.S. Application Data
(60) Provisional application No. 61/923,458, filed on Jan. 3, 2014.

(51) Int. Cl. G09G 3/00

(52) U.S. Cl. CPC G09G 3/007; G09G 2330/00; G09G 2360/04

(57) ABSTRACT

This disclosure provides systems, methods and apparatus for a display device incorporating high-speed data links. A display device can include a controller and a plurality of driver integrated circuits (ICs) for driving portions of a display panel. The controller can communicate data and control signals with the plurality of driver ICs over a plurality of links. The controller can adjust power consumed for communication over one link independently of the power consumed for communication over other links. The controller can adjust power consumed by the controller and a driver IC, as well as transmitter and receiver parameters to provide an acceptable quality of data transmission over the corresponding link. The controller can adjust the power consumed by adjusting a voltage swing of one or more transmission amplifiers and/or controlling the current supplied to receiver amplifiers of the driver ICs.

### CROSS-REFERENCE TO RELATED APPLICATIONS

This Patent Application claims priority to U.S. Provisional Patent Application No. 61/923458 filed Jan. 3, 2014, entitled “Adaptive Power-Efficient High-Speed Data Link Between Display Controller And Component On Glass Driver ICs,” and assigned to the assignee hereof. The disclosure of the prior Application is considered part of and is incorporated by reference in this Patent Application.

### TECHNICAL FIELD

This disclosure relates to the field of imaging displays, and in particular to data communication in displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including a plurality of driver integrated circuits (ICs) configured to drive at least a portion of a display panel and a controller, communicably coupled to each of the plurality of drivers ICs for transmitting data and control signals to the plurality of driver ICs. The controller is configured to independently adjust at least one of a transmission parameter of the controller and a receiver parameter of the plurality of driver ICs to reduce power consumption while maintaining data transmission quality.

In some implementations, the transmission parameter includes at least one of a magnitude of a voltage swing of a transmission amplifier of the controller and a transmission delay of data inputted to a transmission amplifier. In some implementations, the receiver parameter includes at least one of a receiver bandwidth and a receiver sampling delay. In some implementations, the controller is further configured to adjust the receiver bandwidth by adjusting bias currents provided to one or more receiving amplifiers. In some implementations, the controller is further configured to adjust the receiver sampling delay by adjusting delays of programmable delay lines associated with one of the clock signals and one or more data and control signals. In some implementations, the driver ICs are configured to evaluate data transmission errors in data received from the controller and to provide feedback on detected errors to the controller, and wherein the controller is further configured to adjust at least one of the transmission parameter and the receiver parameter based on the feedback.

In some implementations, the apparatus further includes a display, a processor capable of communicating with the display, the processor being capable of processing image data, and a memory device capable of communicating with the processor. In some implementations, the apparatus further includes a driver circuit capable of sending at least one signal to the display, and a controller capable of sending at least a portion of the image data to the driver circuit. In some implementations, the apparatus further includes an image source module capable of sending the image data to the processor, wherein the image source module includes at least one of a receiver, transceiver, and transmitter. In some implementations, the apparatus further includes an input device capable of receiving input data and communicating the input data to the processor.

Another innovative aspect of the subject matter described in this disclosure can be implemented in an apparatus including a controller configured to communicate data and control signals to a plurality of driver integrated circuits (ICs) capable of driving at least a portion of a display panel, communication quality determination means for determining the quality of communication between the controller and the driver ICs, and communication parameter determination means for independently determining parameters of communications between the controller and each of respective driver ICs based on the quality of the communications between the controller and each respective driver IC as determined by the communication quality determination means.

In some implementations, the apparatus further includes bandwidth adjustment means at each driver IC for adjusting bandwidths of receiving amplifiers of the respective driver ICs as determined by the communication parameter determination means. In some implementations, the apparatus further includes voltage adjustment means for adjusting a voltage swing of transmitting amplifiers at the controller as determined by the communication parameter determination means. In some implementations, the apparatus further includes transmitter timing adjustment means for adjusting delay of data provided to transmitting amplifiers at the controller as determined by the communication parameter determination means. In some implementations, the apparatus further includes timing adjustment means for adjusting data sampling delay of at least one of the plurality of driver ICs as determined by the communication parameter determination means.

Another innovative aspect of the subject matter described in this disclosure can be implemented in a system including a processor capable of processing image data to produce processed image data and a display apparatus communicably coupled to the processor. The display panel including a plurality of light modulators for displaying an image, a plurality of driver ICs, coupled to a display panel, capable of driving at least a portion of the display panel, each of the plurality of driver ICs including a plurality of receiving amplifiers for receiving data and control signals via a plurality of links, and a driver controller communicably coupled to the processor and including a plurality of transmitters for transmitting data and control signals to the plurality of driver ICs over the plurality of links. The driver controller is configured to use the processed image data received from the processor to generate the data and control signals transmitted to each of the plurality of driver ICs, and independently adjust at least one of a transmission parameter of the plurality of transmitters and at least one of a receiver parameter of the plurality of receivers to reduce power consumption while maintaining transmission quality of data and control signals over the plurality of communication links.

In some implementations, the transmission parameters include at least one of magnitude of voltage swings of one or more transmission amplifiers of the controller and a transmission delay of data inputted to one or more transmission amplifiers. In some implementations, the receiver parameter includes at least one of receiver bandwidth and a receiver sampling delay. In some implementations, the driver ICs are capable of evaluating data transmission errors in data received from the controller and of providing feedback on detected errors to the controller, and wherein the controller is further configured to further adjust at least one of transmission parameters and receiver parameters based on the feedback.

Another innovative aspect of the subject matter described in this disclosure can be implemented in a method for maintaining data transmission quality between a display controller and a plurality of driver integrated circuits (ICs) configured to drive at least a portion of a display panel. The method includes transmitting calibration data from the controller to the plurality of driver ICs, receiving at the controller data error information from the plurality of driver ICs, and adjusting receiver parameters of one of the plurality of driver ICs independently of receiver parameters of another of the plurality of driver ICs based on the received data error information.

In some implementations, adjusting receiver parameters of one of the plurality of driver ICs independently of receiver parameters of another of the plurality of driver ICs based on the received data error information includes adjusting at least one of receiver bandwidth and receiver sampling delay of one of the plurality of driver ICs. In some implementations, the method further includes adjusting, based on the received data error information, at least one of magnitude of output voltage swing of and a delay of data inputted to a transmission amplifier used for transmitting data to the one of the plurality of driver ICs.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a block diagram of an example display device.

FIG. 4 shows a block diagram of another example display device.

FIG. 5 shows a block diagram of a portion of an example implementation of the display device shown in FIG. 4.

FIG. 6 shows a flow diagram of an example process for adaptively calibrating the display device shown in FIG. 5.

FIG. 7 shows a block diagram of a portion of another example implementation of the display device shown in FIG. 4.

FIGS. 8A and 8B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A display device can include a controller and a plurality of driver integrated circuits (ICs) for driving portions of a display panel. The controller can communicate data and control signals with the plurality of driver ICs over a plurality of links. In some implementations, the controller can adjust power consumed for communication over one link independently of the power consumed for communication over other links. In some implementations, the controller can adjust power consumed by the controller and a driver IC, as well as transmitter and receiver parameters to provide sufficient quality of data transmission over the corresponding link.

In some implementations, the controller can adjust the power consumed by the controller by adjusting a voltage swing of the output of one or more transmission amplifiers. In some implementations, the controller can adjust the power consumed by the driver IC by controlling the current supplied to receiver amplifiers of the driver ICs. In some implementations, the driver ICs can evaluate communication errors in communications received from the controller and provide feedback on detected errors to the controller to enable the controller to further adjust transmitter and receiver parameters to improve the quality of communications.

Particular implementations of the subject matter described in this disclosure can be implemented to realize one or more of the following potential advantages. By controlling power consumed for communication over one link independently of that consumed for communications over other links between a controller and a plurality of driver ICs driving portions of a display panel can provide overall reduction in power consumption of a display device while maintaining acceptable levels of communication reliability over the communication links.

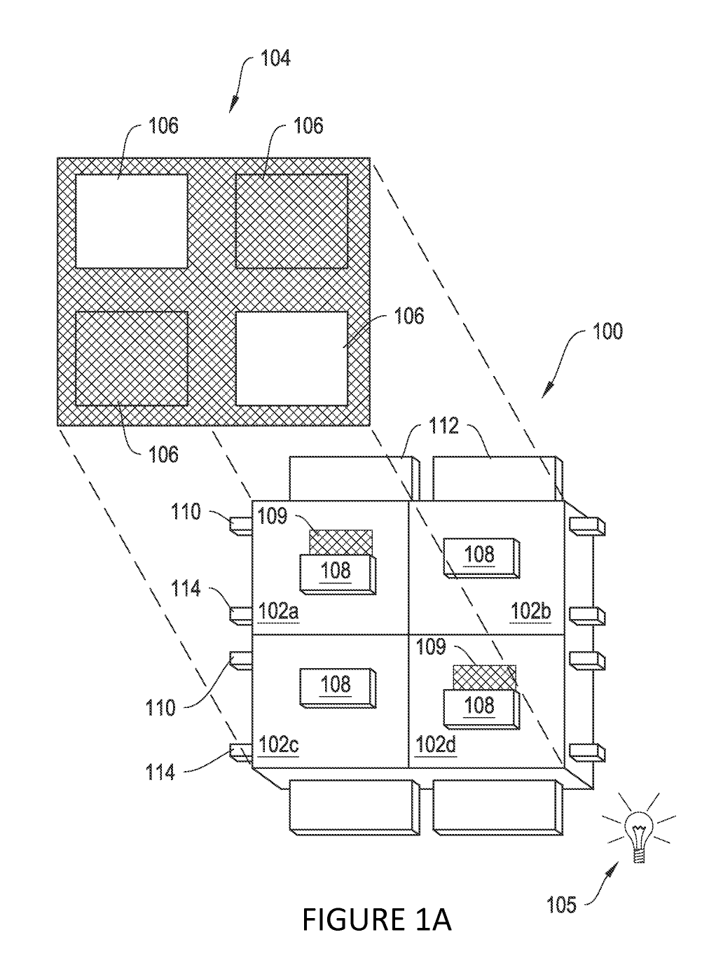

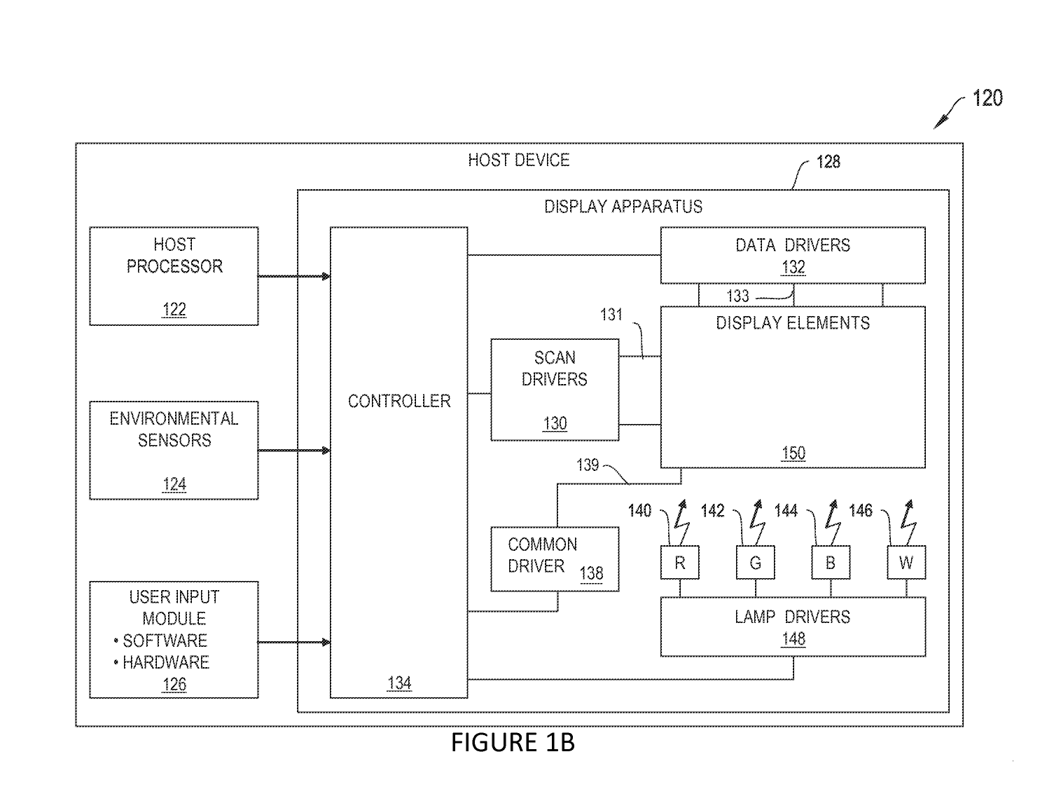

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

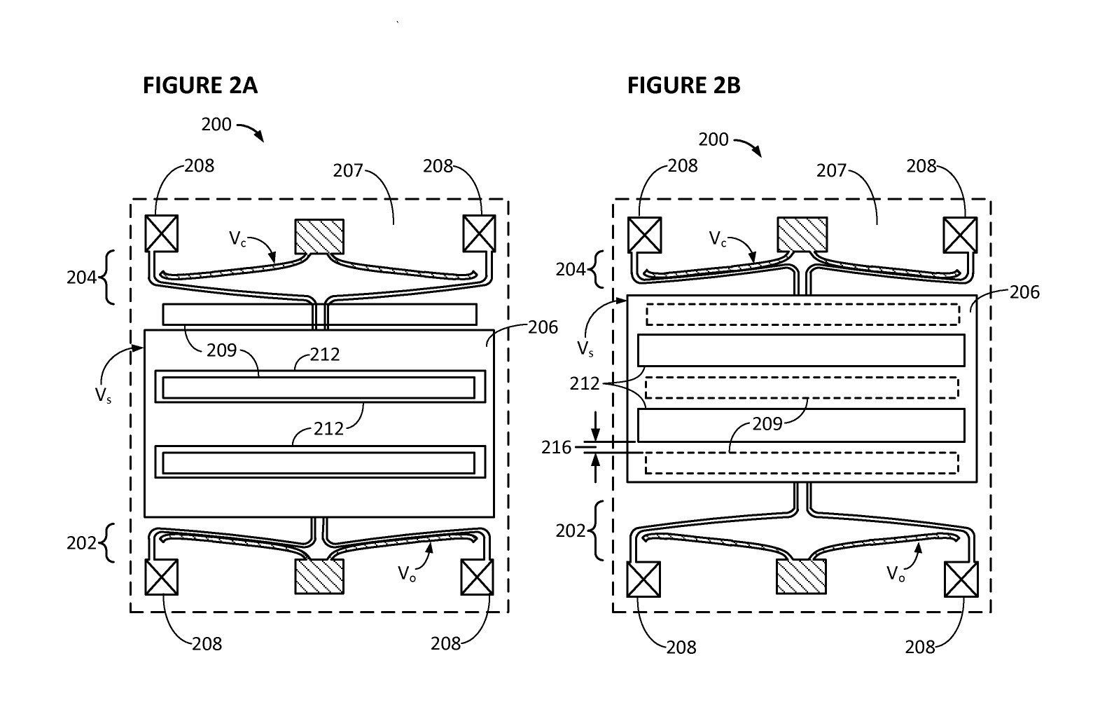

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage V.

Electrical bi-stability in electrostatic actuators, such as actuators 202 and 204, can arise from the fact that the electrostatic force across an actuator is a function of position as well as voltage. The beams of the actuators in the shutter assembly 200 can be implemented to act as capacitor plates. The force between capacitor plates is proportional to 1/d² where d is the local separation distance between capacitor plates. When the actuator is in a closed state, the local separation between the actuator beams is very small. Thus, the application of a small voltage can result in a relatively strong force between the actuator beams of the actuator in the closed state. As a result, a relatively small voltage, such as Vₘ, can keep the actuator in the closed state, even if other elements exert an opposing force on the actuator.

In dual-actuator light modulators, the equilibrium position of the light modulator can be determined by the combined effect of the voltage differences across each of the actuators. In other words, the electrical potentials of the three terminals, namely, the shutter open drive beam, the shutter close drive beam, and the load beams, as well as modulator position, can be considered to determine the equilibrium forces on the modulator.

For an electrically bi-stable system, a set of logic rules can describe the stable states and can be used to develop reliable addressing or digital control schemes for a given light modulator. Referring to the shutter assembly 200 as an example, these logic rules are as follows:

Let Vₛ be the electrical potential on the shutter or load beam. Let Vₒ be the electrical potential on the shutter-open drive beam. Let V_{c} be the electrical potential on the shutter-close drive beam. Let the expression |Vₒ-Vₛ| refer to the absolute value of the voltage difference between the shutter and the shutter-open drive beam. Let Vₘ be the maintenance voltage. Let Vₐₜ be the actuation threshold voltage, i.e., the voltage to actuate an actuator absent the application of Vₘ to an opposing drive beam. Let Vₘₐₓ be the maximum allowable potential for Vₒ and V_{c}. Let Vₘ<Vₐₜ<Vₘₐₓ. Then, assuming Vₒ and V_{c} remain below Vₘₐₓ:

If |Vₒ-Vₛ|<Vₘ and |V_{c}-Vₛ|<Vₘ (rule 1)

Then the shutter will relax to the equilibrium position of its mechanical spring.

If |Vₒ-Vₛ|>Vₘ and |V_{c}-Vₛ|>Vₘ (rule 2)

Then the shutter will not move, i.e., it will hold in either the open or the closed state, whichever position was established by the last actuation event.

If |Vₒ-Vₛ|>Vₐₜ and |V_{c}-Vₛ|<Vₘ (rule 3)

Then the shutter will move into the open position.

If |Vₒ-Vₛ|<Vₘ and |V_{c}-Vₛ|>Vₐₜ (rule 4)

Then the shutter will move into the closed position.

Following rule 1, with voltage differences on each actuator near zero, the shutter will relax. In many shutter assemblies, the mechanically relaxed position is partially open or closed, and so this voltage condition is usually avoided in an addressing scheme.

The condition of rule 2 makes it possible to include a global actuation function into an addressing scheme. By maintaining a shutter voltage which provides beam voltage differences that are at least the maintenance voltage, Vₘ the absolute values of the shutter open and shutter closed potentials can be altered or switched in the midst of an addressing sequence over wide voltage ranges (even where voltage differences exceed Vₐₜ) with no danger of unintentional shutter motion.

The conditions of rules 3 and 4 are those that are generally targeted during the addressing sequence to ensure the bi-stable actuation of the shutter. p The maintenance voltage difference, Vₘ, can be designed or expressed as a certain fraction of the actuation threshold voltage, Vₐₜ. For systems designed for a useful degree of bi-stability, the maintenance voltage can exist in a range between about 20% and about 80% of Vₐₜ. This helps ensure that charge leakage or parasitic voltage fluctuations in the system do not result in a deviation of a set holding voltage out of its maintenance range—a deviation which could result in the unintentional actuation of a shutter. In some systems, an exceptional degree of bi-stability or hysteresis can be provided, with Vₘ, existing over a range of about 2% and about 98% of Vₐₜ. In these systems, however, care must be taken to ensure that an electrode /voltage condition of |V_{c}-Vₛ| or |Vₒ-Vₛ| being less than Vₘ can be reliably obtained within the addressing and actuation time available.

In some implementations, the first and second actuators of each light modulator are coupled to a latch or a drive circuit to ensure that the first and second states of the light modulator are the two stable states that the light modulator can assume.

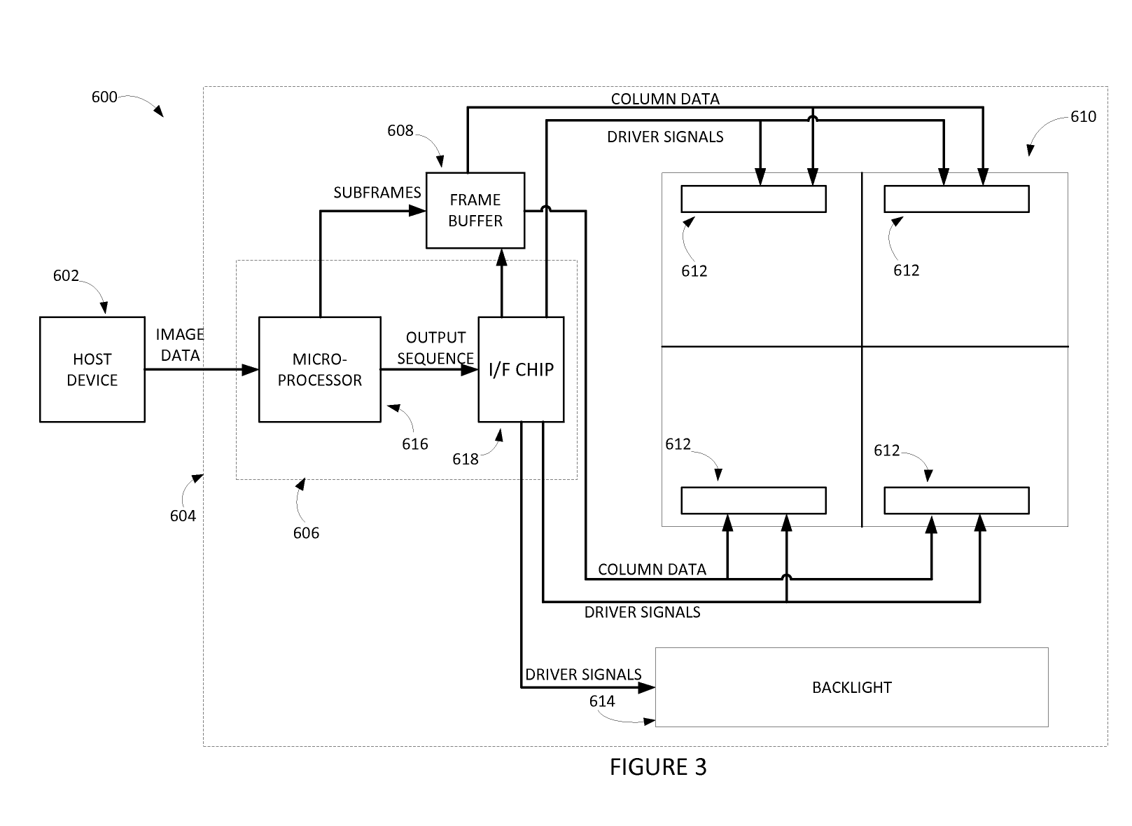

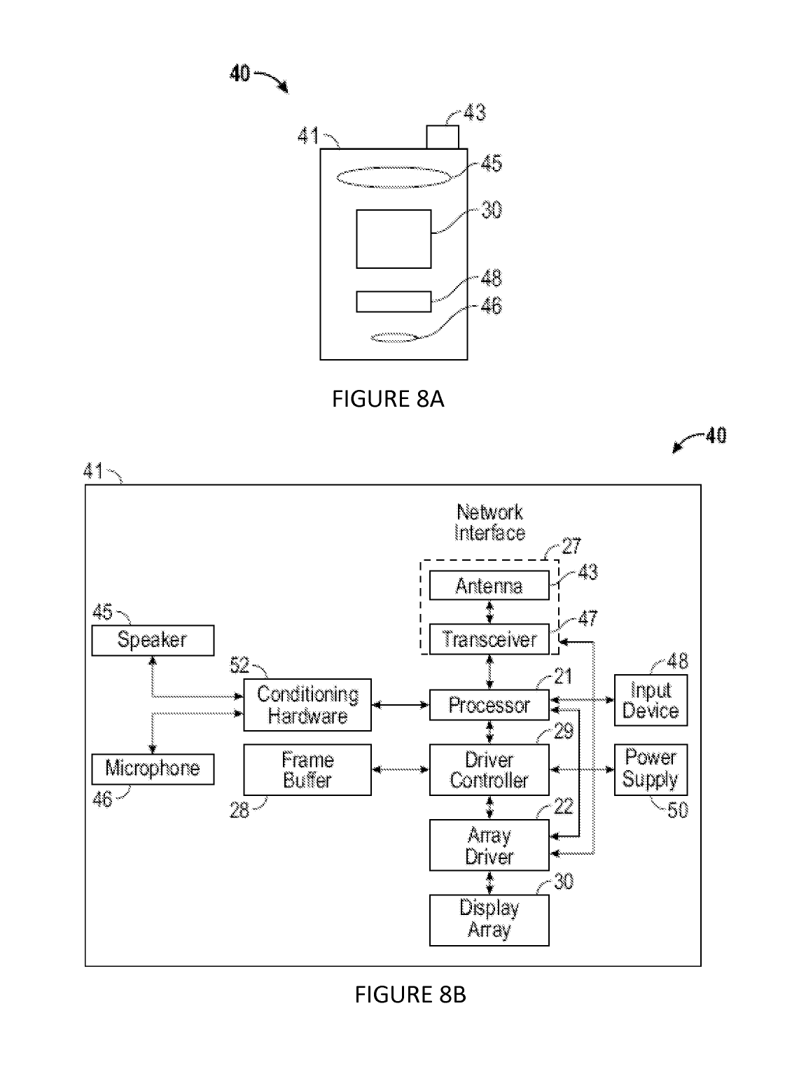

FIG. 3 shows a block diagram of an example display apparatus 600. The display apparatus 600 includes a host device 602 and a display module 604. The host device 602 can be an example of the host device 120 and the display module 604 can be an example of the display apparatus 128, both shown in FIG. 1B. The host device 602 can be any of a number of electronic devices, such as a portable telephone, a smartphone, a watch, a tablet computer, a laptop computer, a desktop computer, a television, a set top box, a DVD or other media player, or any other device that provides graphical output to a display, similar to the display device 40 shown in FIGS. 8A and 8B below. In general, the host device 602 serves as a source for image data to be displayed on the display module 604.

The display module 604 further includes control logic 606, a frame buffer 608, an array of display elements 610, display drivers 612 and a backlight 614. In general, the control logic 606 serves to process image data received from the host device 602 and controls the display drivers 612, array of display elements 610 and backlight 614 to together produce the images encoded in the image data. The control logic 606, frame buffer 608, array of display elements 610, and display drivers 612 shown in FIG. 3 can be similar, in some implementations, to the driver controller 29, frame buffer 28, display array 30, and array drivers 22 shown in FIGS. 8A and 8B, below.

In some implementations, as shown in FIG. 3, the functionality of the control logic 606 is divided between a microprocessor 616 and an interface (I/F) chip 618. In some implementations, the interface chip 618 is implemented in an integrated circuit logic device, such as an application specific integrated circuit (ASIC). In some implementations, the microprocessor 616 is configured to carry out all or substantially all of the image processing functionality of the control logic 606. In addition, the microprocessor 616 can be configured to determine an appropriate output sequence for the display module 604 to use to generate received images. For example, the microprocessor 616 can be configured to convert image frames included in the received image data into a set of image subframes. Each image subframe can be associated with a color and a weight, and includes desired states of each of the display elements in the array of display elements 610. The microprocessor 616 also can be configured to determine the number of image subframes to display to produce a given image frame, the order in which the image subframes are to be displayed, timing parameters associated with addressing the display elements in each subframe, and parameters associated with implementing the appropriate weight for each of the image subframes. These parameters may include, in various implementations, the duration for which each of the respective image subframes is to be illuminated and the intensity of such illumination. The collection of these parameters (i.e., the number of subframes, the order and timing of their output, and their weight implementation parameters for each subframe) can be referred to as an “output sequence.”

The interface chip 618 can be capable of carrying out more routine operations of the display module 604. The operations may include retrieving image subframes from the frame buffer 608 and outputting control signals to the display drivers 612 and the backlight 614 in response to the retrieved image subframe and the output sequence determined by the microprocessor 616. In some other implementations, the functionality of the microprocessor 616 and the interface chip 618 are combined into a single logic device, which may take the form of a microprocessor, an ASIC, a field programmable gate array (FPGA) or other programmable logic device. For example, the functionality of the microprocessor 616 and the interface chip 618 can be implemented by a processor 21 shown in FIG. 8B. In some other implementations, the functionality of the microprocessor 616 and the interface chip 618 may be divided in other ways between multiple logic devices, including one or more microprocessors, ASICs, FPGAs, digital signal processors (DSPs) or other logic devices.

The frame buffer 608 can be any volatile or non-volatile integrated circuit memory, such as DRAM, high-speed cache memory, or flash memory (for example, the frame buffer 608 can be similar to the frame buffer 28 shown in FIG. 8B). In some other implementations, the interface chip 618 causes the frame buffer 608 to output data signals directly to the display drivers 612. The frame buffer 608 has sufficient capacity to store color subfield data and subframe data associated with at least one image frame. In some implementations, the frame buffer 608 has sufficient capacity to store color subfield data and subframe data associated with a single image frame. In some other implementations, the frame buffer 608 has sufficient capacity to store color subfield data and subframe data associated with at least two image frames. Such extra memory capacity allows for additional processing by the microprocessor 616 of image data associated with a more recently received image frame while a previously received image frame is being displayed via the array of display elements 610.

In some implementations, the display module 604 includes multiple memory devices. For example, the display module 604 may include one memory device, such as a memory directly associated with the microprocessor 616, for storing subfield data, and the frame buffer 608 is reserved for storage of subframe data.

The array of display elements 610 can include an array of any type of display elements that can be used for image formation. In some implementations, the display elements can be EMS light modulators. In some such implementations, the display elements can be MEMS shutter-based light modulators similar to those shown in FIGS. 2A or 2B. In some other implementations, the display elements can be other forms of light modulators, including liquid crystal light modulators, other types of EMS- or MEMS-based light modulators, or light emitters, such as OLED emitters, configured for use with a time division gray scale image formation process.

The display drivers 612 can include a variety of drivers depending on the specific control matrix used to control the display elements in the array of display elements 610. In some implementations, the display drivers 612 include a plurality of scan drivers similar to the scan drivers 130, a plurality of data drivers similar to the data drivers 132, and a set of common drivers similar to the common drivers 138, as shown in FIG. 1B. As described above, the scan drivers output write enabling voltages to rows of display elements, while the data drivers output data signals along columns of display elements. The common drivers output signals to display elements in multiple rows and multiple columns of display elements.

In some implementations, particularly for larger display modules 604, the control matrix used to control the display elements in the array of display elements 610 is segmented into multiple regions. For example, the array of display elements 610 shown in FIG. 3 is segmented into four quadrants. A separate set of display drivers 612 is coupled to each quadrant. Dividing a display into segments in this fashion can reduce the propagation time needed for signals output by the display drivers to reach the furthest display element coupled to a given driver, thereby decreasing the time needed to address the display. Such segmentation also can reduce the power requirements of the drivers employed.

In some implementations, the display elements in the array of display elements can be utilized in a direct-view transmissive display. In direct-view transmissive displays, the display elements, such as EMS light modulators, selectively block light that originates from a backlight, such as the backlight 614, which is illuminated by one or more lamps. Such display elements can be fabricated on transparent substrates, made, for example, from glass. In some implementations, the display drivers 612 are coupled directly to the glass substrate on which the display elements are formed. In such implementations, the drivers are built using a chip-on-glass configuration. In some other implementations, the drivers are built on a separate circuit board and the outputs of the drivers are coupled to the substrate using, for example, flex cables or other wiring.

The backlight 614 can include a light guide, one or more light sources (such as LEDs), and light source drivers. The light sources can include light sources of multiple colors, such as red, green, blue, and in some implementations white. The light source drivers are capable of individually driving the light sources to a plurality of discrete light levels to enable illumination gray scale and/or content adaptive backlight control (CABC) in the backlight. In addition, lights of multiple colors can be illuminated simultaneously at various intensity levels to adjust the chromaticities of the component colors used by the display, for example to match a desired color gamut. Lights of multiple colors also can be illuminated to form composite colors. For displays employing red, green, and blue component colors, the display may utilize a composite color white, yellow, cyan, magenta, or any other color formed from a combination of two or more of the component colors.

The light guide distributes the light output by light sources substantially evenly beneath the array of display elements 610. In some other implementations, for example for displays including reflective display elements, the display apparatus 600 can include a front light or other form of lighting instead of a backlight. The illumination of such alternative light sources can likewise be controlled according to illumination gray scale processes that incorporate content adaptive control features. For ease of explanation, the display processes discussed herein are described with respect to the use of a backlight. However, it would be understood by a person of ordinary skill that such processes also may be adapted for use with a front light or other similar form of display lighting.

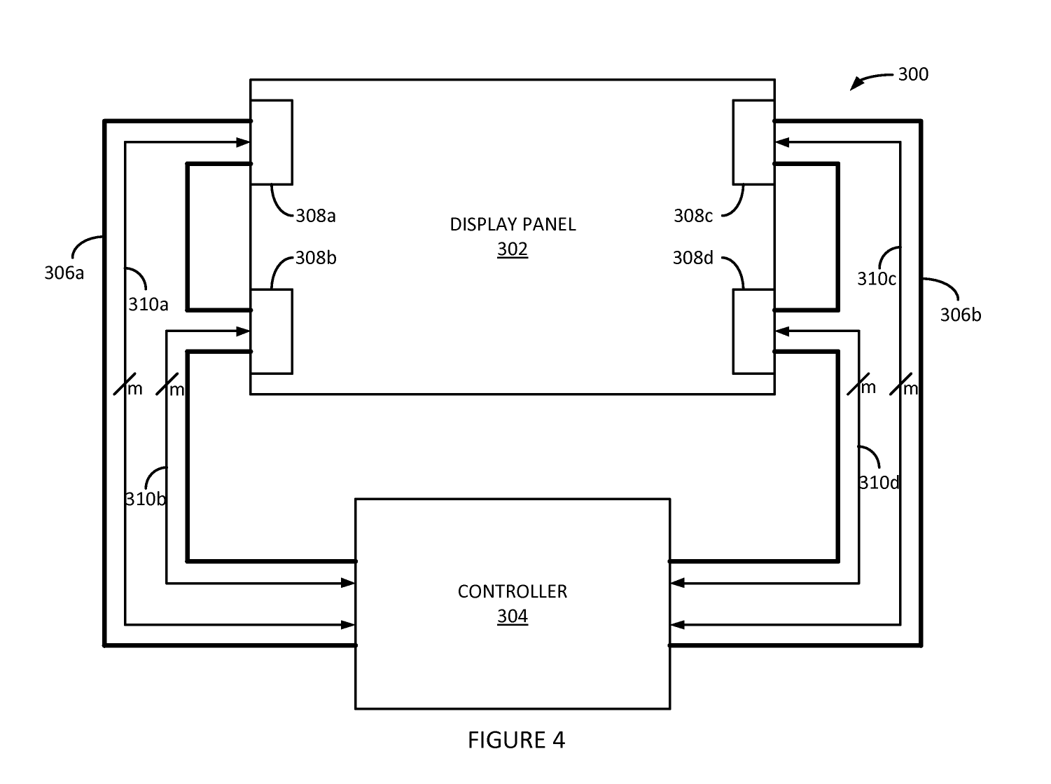

FIG. 4 shows a block diagram of another example display device 300. In particular, the display device 300 includes a display panel 302, a controller 304 and flex cables 306a and 306b. The controller 304 can be similar to the controller 134 discussed above in relation to FIG. 1B. The display panel 302 includes four driver integrated circuits (ICs): a first driver IC 308a, a second driver IC 308b, a third driver IC 308c and a fourth driver IC 308d, each providing drive and data signals to pixels in a corresponding quadrant of the display panel 302. Each of the four driver ICs 308a-308d can include a plurality of data receivers for receiving data signals and one or more control transceivers for communicating control signals to and from the controller 304.

The flex cables 306a and 306b can provide physical interconnects or links for carrying data and control signals between the controller 304 and the display panel 302. In particular, the flex cable 306a includes a first link 310a and a second link 310b for communicably connecting the first driver IC 308a and the second driver IC 308b, respectively, to the controller 304. Similarly, the flex cable 306b includes a third link 310c and a fourth link 310d for communicably connecting the third driver IC 308c and the fourth driver IC 308d, respectively, to the controller 304. Each of the four links 310a-310d can include m interconnects. In some implementations, the m interconnects can include n data interconnects and/control interconnects. In some implementations, additional control links located outside the flex cables 306a and 306b can be provided between the controller 304 and the four driver ICs 308a-308d.

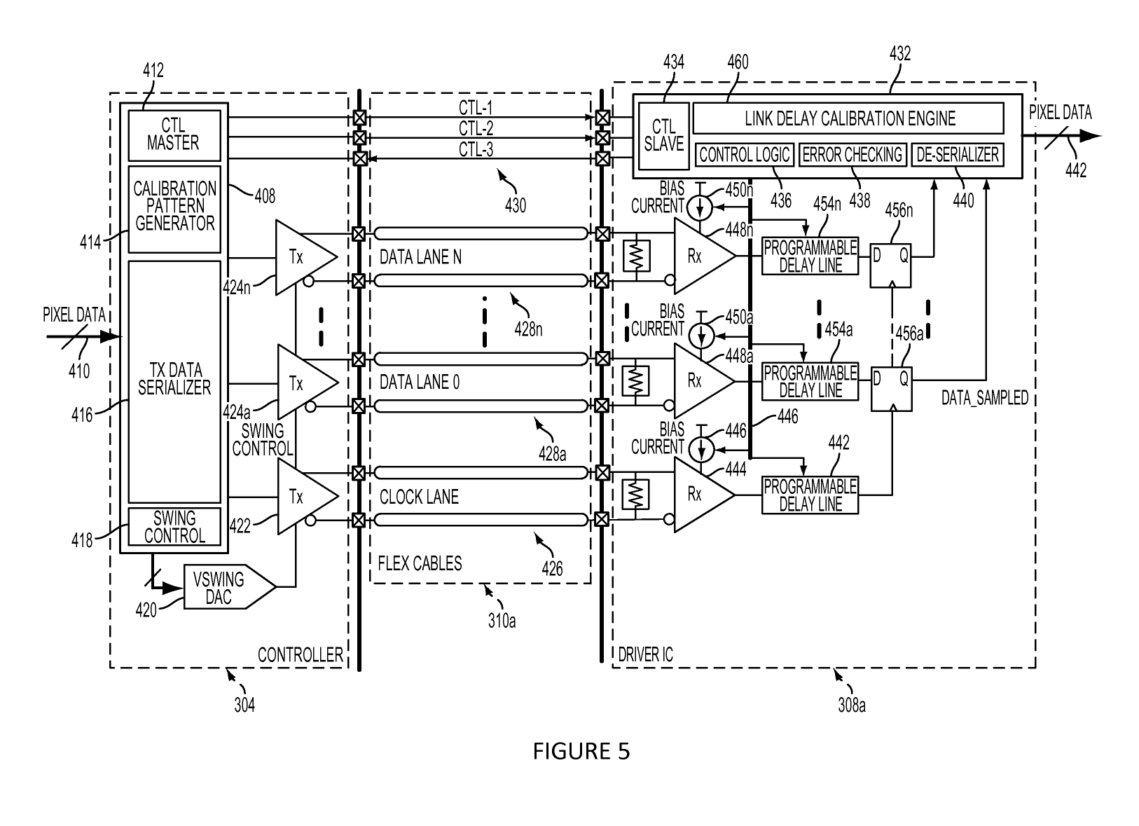

FIG. 5 shows a block diagram of a portion of an example implementation of the display device 300 shown in FIG. 4. In particular, FIG. 5 shows the controller 304 connected to the first driver IC 308a via the first link 310a. The first link 310a can include several interconnects dedicated to carrying specific signals between the controller 308 and the first driver IC 308a. For example, the first link 310a includes a clock lane 426 for carrying clock signals, data lanes 0-N428a-428n for carrying data signals, and control lanes 430 (including control lanes CTL-1, CTL-2, and CTL-3) for carrying control signals. In some implementations, the clock lane 426 and the data lanes 0-N428a-428n can include dual rails.

The controller 304 includes a control module 408, which receives pixel data. In some implementations, the pixel data can be received over a parallel bus 410, for example, an 8-bit bus. The control module 408 also can include a CTL Master module 412, a calibration and pattern generator 414, a transmission data serializer 416, and a swing control module 418. The CTL Master module 412 can be utilized to communicate with a corresponding CTL slave module 434 at the first driver IC 308a. For example, the CTL Master module 412 can communicate with the CTL slave module at the first driver IC 308a to send control data instructing the first driver IC 308a to enter or exit a calibration mode. In some other implementations, the CTL Master module 412 may receive calibration results from the first driver IC 308a. The calibration pattern generator 414 can generate a series of ‘0’s and ‘1’s which can be transmitted to any one of the four driver ICs 308a-308d to perform communication calibration. The transmission data serializer 416 can serialize the parallel pixel data received over the parallel bus 410 into serial pixel data.

The controller 304 also can include a number of transmission amplifiers for transmitting data and control signals to the driver ICs 308a-308d, however, FIG. 5 shows those transmission amplifiers associated with transmitting data and control signals to the first driver IC 308a via the first link 310a. For example, the controller 304 can include a clock transmission amplifier 422 for transmitting clock signals over the clock lane 426 and data transmission amplifiers 424a-424n for transmitting data signals over the data lanes 0-N428a-428n. In some implementations, each of the clock transmission amplifier 422 and the data transmission amplifiers 428a-428n can have single ended inputs and dual ended differential outputs. That is, each transmission amplifier can amplify a voltage received at its single ended input and generate an amplified voltage at each of its dual ended differential outputs. The voltage at each of the dual ended differential outputs can be of the same magnitude but have opposite phases (that is, a relative phase difference of about 180° or about π radians). The voltage measured across the dual ended differential outputs can be represented by a differential voltage output. In some implementations, the dual ended differential outputs can be connected to dual rail clock or data lanes (such as clock lane 426 and data lanes 0-N428a-428n). In some such implementations, the transmission amplifiers can output differential signals over the dual rail lanes. In some other implementations, the transmission amplifiers may have a single ended output, and may output single ended voltage signals over single rail lanes.

As mentioned above, each of the transmission amplifiers 422 and 424a-424n can output a differential voltage across its respective dual ended differential outputs. In some implementations, a voltage swing can represent the magnitude of the differential voltage across the dual ended differential outputs of the transmission amplifier. The voltage swing can vary based on the data being transmitted. For example, in some implementations, the transmission of a ‘0’ can be represented by a voltage swing of about 0 mV, while the transmission of a ‘1’ can be represented by a voltage swing of about 500 mV. These voltage swing values are examples, and may vary based on the implementation. In some implementations, where single ended output transmission amplifiers are utilized for transmission of data over single rail lanes, the voltage swing also can represent the magnitude of the single ended voltage signals output by the single ended output transmission amplifiers.

In some implementations, the clock signal output by the clock transmission amplifier 422 is output at a phase shift of about 90 degrees (or odd multiples of 90 degrees or π/2 radians) with respect to the data signals output by the data transmission amplifiers 428a-428n. This 90 degree phase shift can allow the driver ICs to reliably sample and digitize the received data signals at both edges of the clock thus doubling the available data rate (DDR).

In some implementations, the controller 304 can control the voltage swing of one or more transmission amplifiers 422 and 424a-424n. For example, the control module 408 can include a swing control module 418 for controlling the voltage swing. In some implementations, the output of the swing control module can be a digital signal. For example, the swing control module may output a digital control value corresponding to a desired voltage swing at the outputs of one or more transmission amplifiers 422 and 428a-428n. In some such implementations, the digital control value output of the swing control module 418 can be fed to a digital to analog converter (DAC) 420. The DAC 420 can convert the digital control value into an analog control value, which in turn is used to control one or more transmission amplifiers 422 and 424a-424n such that the differential voltage at the dual ended outputs of the one or more transmission amplifiers 422 and 424a-424n has the desired magnitude. In some implementations, the swing control module 418 can control the voltage swing of one or more transmission amplifiers 422 and 424a-424n from about 0 mV to about 500 mV.

In some implementations, the power consumed by the transmission amplifiers 422 and 424a-424n can be reduced by reducing the voltage swing at their outputs. In some implementations, reducing the power consumption by way of reducing the voltage swing may come at the cost of increased data errors in the data received at the driver ICs 308a-308d. In some implementations, these errors may be mitigated by adjusting the phase shift between the data and clock signals (i.e., adjusting the time when the data signal is sampled). However, in some instances, the voltage swing may be too low to generate a detectable data signal at the output of a receiving amplifier. In such instances, adjusting the phase shifts may not yield error reduction.

The first driver IC 308a can include a first receiver module 432, a clock receiver amplifier 444 and n data receiver amplifiers 448a-448n. The inputs of the clock receiver amplifier 444 are coupled to the clock lane 426, while the inputs of each of the n data receiver amplifiers 448a-448n are coupled to the data lanes 0-N428a-428n, respectively. Each of the receiving amplifiers 444 and 448a-448n can be differential amplifiers with dual ended differential inputs and single ended outputs. The receiving amplifiers can output a voltage signal corresponding to the voltage swing applied to their dual ended differential inputs.

The outputs of the receiver amplifiers 448a-448n are sampled and fed to the receiver control module 432. In some implementations, the sampling of the outputs of the data receiver amplifiers 448a-448n can be carried out using programmable delay lines and D flip-flops. For example, the output of each of the data receiver amplifiers 448a-448n is fed to one of n programmable data delay lines 454a-454n followed by one of n D flip-flops 456a-456n. Each of the n D flip-flops is triggered by the output of the clock receiver amplifier 444, which is itself delayed via a programmable clock delay line 442.

The programmable delay lines 442 and 454a-454n can introduce a programmable delay or a phase shift between their respective input signals and their respective output signals. In some implementations, the programmable delay lines can be implemented using an open-loop delay line or a closed-loop delay-locked loop. The delays introduced by the programmable delay lines 442 and 454a-454n can be controlled by the first receiver module 432. The delays of the programmable delay lines 442 and 454a-454n can be adjusted to maintain a phase shift between the received data signals and the received clock signal. As mentioned above, in some implementations, the desired phase shift is about 90 degrees.

In some implementations, the bandwidth of each of the receiving amplifiers 444 and 448a-448n can be controlled. For example, the receiving amplifiers 444 and 448a-448n can include bias current sources 446 and 450a-450n, respectively for controlling the supplied bias current. The supplied bias current can, in turn, control the bandwidth of the receiving amplifiers 444 and 448a-448n. For example, increasing the bias current can increase the bandwidth, while reducing the bias current can decrease the bandwidth. In some implementations, the power consumed by the receiving amplifiers 444 and 448a-448n can be increased or decreased based on the supplied bias current. That is, the supplied bias current can be reduced to reduce power consumption while increasing the bias current increases the power consumption. A desired decrease in the power consumption can come at the cost of decrease in the bandwidth. Decrease in the bandwidth may increase the likelihood of errors in the data received by the driver IC 308a. In some implementations, these errors may be mitigated by adjusting the phase shift between the data and clock signals.

The receiver module 432 can include a link delay calibration engine 460, control logic 436, an error checking module 438, a de-serializer 440 and a CTL slave module 434. The link delay calibration engine 460 can determine the delay of each of the programmable delay lines 454a-454n. The control logic 436 can send control signals to the bias current sources 446 and 450a-450n to control their respective supplied bias currents. Thus, the control logic 436 can effectively control the bandwidth of, and the power consumed by, the receiving amplifiers 444 and 448a-448n. The control logic 436 also can send control signals to each of the programmable delay lines 454a-454n for controlling their respective delays. The de-serializer 440 can convert the serial pixel data received from the D flip-flops 456a-456n into parallel data, which can be output to the pixel array. The CTL slave module 434 can communicate control and feedback data back to the controller 304 via control line CTL-1. In some implementations, the CTL slave module 434 can transmit the result of data error checking carried out by the error checking module 438.

In some implementations, power consumption of the display device 300 can be dynamically adjusted by adjusting the power consumed by the controller 304 and one or more of the driver ICs 308a-308d. In particular, the power consumption of the transmission amplifiers 422 and 424a-424n can be reduced by reducing the voltage swings at the outputs of the transmission amplifiers 422 and 424a-424n. As mentioned above, the power consumption can be further reduced by reducing the power consumed by the receiving amplifiers 444 and 448a-448n (by reducing their respective supplied bias currents). In some implementations, reducing the power consumption at controller 304 and the driver ICs 308a-308d can result in degradation of communication signals. To compensate for this degradation in communication, in some implementations, the controller 304 can control data sampling parameters (such as the delays of the programmable delay lines 442 and 454a-454n) at the driver ICs 308a-308d. In some implementations, the controller 304 can adaptively lower the power consumption of the display device 300 while still maintaining sufficient data transmission quality.

In some implementations, for the same transmission power, data communications over longer links may be more error prone than that over shorter links. Transmission power can include the power consumed by the transmission amplifiers in the controller and the receiving amplifiers in the driver ICs. In some such implementations, the controller 304 may drive all links using transmission power that is calibrated for reliable data transmission over the longest link. But, this may result in undue power losses over shorter links, which do not require such high transmission power for reliable data transmission. Thus, it is desirable to be able to set the transmission power for data transmission over a link independently of the transmission power set for data transmission over a different link. For example, overall power consumption may be reduced if the controller 304 can set the transmission power for data transmission over each of the four links 310a-310d independently.

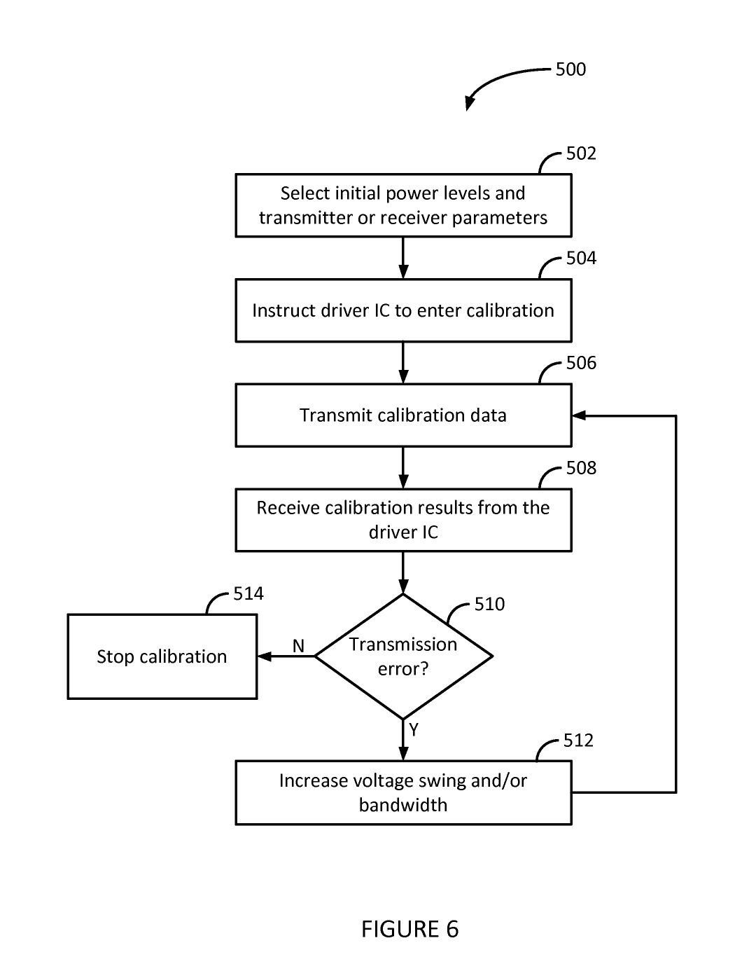

FIG. 6 shows a flow diagram of an example process 500 for adaptively calibrating the display device shown in FIG. 5. In particular, the process 500 can be executed by the controller 304 to adaptively calibrate power consumption and the quality of communication between the controller 304 and the first driver IC 308a It is understood that the process 500 can be executed by the controller 304 for calibrating each of the other driver ICs 308b-308d shown in FIG. 4. The process 500 includes selecting initial power levels and transmitter or receiver parameters (stage 502), instructing the driver IC to enter a calibration mode (stage 504), transmitting calibration data (stage 506), receiving calibration results from the driver IC (stage 508), determining whether transmission error occurred at the driver IC (stage 510), increasing a voltage swing of the transmitter and/or the bandwidth of the receiver if transmission error occurred (stage 512), and stopping calibration if no transmission error is detected (stage 514).

The process 500 includes selecting initial power levels and transmitter or receiver parameters, or sometimes both (stage 502). In this process stage, the controller 304 can select initial transmission and receive parameters for the controller 304 and the first driver IC 308a. For example, the controller 304 can set a relatively low initial power consumption level for the transmitting amplifiers 422 and 424a-424n. Based on the selected power levels, the swing controller 418 can set corresponding initial values for the output voltage swings for the clock transmission amplifier 422 and each of the n data transmission amplifiers 424a-424n. In some implementations, the controller 304 also may select relatively low power levels of the receiving amplifiers 444 and 448a-448n. Based on the selected power levels, the controller can transmit the desired power level to the control logic 436 of the first driver IC 308a and allow the control logic 436 to select the corresponding bias currents for the receiving amplifiers 444 and 448a-448n. In some other implementations, the controller 304 may instead transmit the bias current levels to the control logic 436.

The process 500 also includes instructing the driver IC to enter a calibration mode (stage 504). In this process stage, the controller 304 can send control signals to the receiver controller 432 to enter the calibration mode via the CTL master module 412. In some implementations, the controller 432 also may send initial delay line parameters to the driver IC 308a. For example, in some implementations, the controller 304 can instruct the driver IC 308a to set the delays for the clock delay line 442 and the data delay lines 454a-454n to zero, or substantially zero. Upon receiving the instruction to enter the calibration mode from the controller 304, the driver IC 308a can power the error checking module 438 and the link calibration engine 460.

The process 500 further includes transmitting calibration data (stage 506). In this process stage, the calibration pattern generator 414 can generate a series of calibration bits that can be transmitted over the data lanes 0-N428a-428n. For example, the calibration bits can include an alternating series of ‘0’s and ‘1’s. In some other implementations, the calibration bits can be a repeated series of the bit pattern: ‘00001111’ or any other suitable pattern. In some other implementations, data and control signals associated with image data can be utilized as calibration data in place of the calibration bits generated by the calibration pattern generator 414. In some implementations, the calibration data can be followed by an error correction code, such as cyclic redundancy check (CRC) code.

The driver IC 308a. upon receiving the calibration data, can execute a calibration routine using the link delay calibration engine 460 to determine any errors in received calibration data. In some implementations, the calibration routine can include generating a CRC code for the received data and comparing the generated CRC code with the CRC code received from the controller 304. The result of the comparison can be transmitted to the controller 304 via CTL lanes 430. In some other implementations, the calibration routine can include varying relative phases of the clock and of the received data signals to determine the values for which the transmission error is below an acceptable level. In some implementations, the acceptable level can be zero errors. In some other implementations, the acceptable level can correspond to an error rate below which visual artifacts resulting from the errors are within tolerable limits of the human visual system. For example, in some implementations, the calibration engine 460 can vary the delay for each of the data programmable delay lines 454a-454n over its entire range for a single delay value set for the clock programmable delay line 442. This process of varying the delay for the data programmable delay lines 454a-454n can be repeated for various delay values set for the clock programmable delay line 442 until the transmission error is below the acceptable level. Thus, for a given set of values for power related parameters such as output voltage swing of the transmission amplifiers and the bandwidth of the receiver amplifiers, the driver IC 308a can determine whether at least one set of delay values exists for the programmable delay lines 454a-454n and the clock programmable delay line 442 for which the transmission error is below an acceptable level. The outcome of the calibration routine executed by the calibration engine 432 can be transmitted to the controller 304 via CTL lanes 430.

In some implementations, the calibration routine executed at the driver IC 308a also may determine a bit error rate associated with the received calibration data. Transmitting the bit error rate to the controller 304 can provide the controller 304 with additional information on the errors encountered in receiving the calibration data at the driver IC 308a.

The process also includes receiving calibration results from the driver IC 308a (stage 508). In this process stage, the controller 304 can receive the results of the calibration routine executed by the calibration engine 460. In some implementations, the controller 304 can receive an indication whether the calibration routine executed by the calibration engine 460 detected an error in the received calibration data. In some implementations, the controller 304 can receive an indication whether errors above an acceptable level were detected. In some implementations, the controller 304 can receive a bit error rate determined by the calibration routine executed at the driver IC 308a.

An error (or errors over an acceptable level) in the received calibration data can indicate that the power may have to be increased or the delay parameters may have to be further adjusted to provide reliable transmission of data (having no transmission errors or having errors below acceptable levels) between the controller 304 and the driver IC 308a. Thus, if this condition is true, the controller can increase one or both of the voltage swing of the transmission amplifier 424a and the bandwidth of the receiver amplifier 448a (stage 512). The controller 304 also may instruct the driver IC 308a to further vary the delay parameters. Subsequently, the controller 304 transmits additional calibration data (stage 506) and receives new calibration results from the driver IC 308a (stage 508). If transmission errors persist, then the power can be further increased and/or the delay parameters can be further altered until no transmission error is detected or until the transmission errors are below acceptable levels.

Once transmission errors cease or are below acceptable levels, either due to successive increase in the power consumption or due to changes in the delay parameters, the calibration can be stopped (stage 514). In process stage 514, the controller 304 can store the latest values of parameters such as the voltage swing, the bandwidth, and the delays. The controller 304 can use these stored values for transmitting data to the driver IC 308a.

The process 500, discussed above, begins with selecting low power consumption levels, and gradually increases the power consumption levels until no transmission errors are detected or until transmission errors are below acceptable levels. Alternatively, in some other implementations, the process 500 can be modified to begin with power consumption levels that are known to not introduce any transmission errors or are known to have transmission errors below acceptable levels, and then successively decreasing the power consumption levels until the first occurrence of transmission errors or an increase in transmission errors above acceptable levels. In this manner a lower bound to the power consumption levels for which no errors or for which errors below acceptable levels are detected can be determined

The controller 304 can repeat the process 500 for determining the desired power consumption levels and transmission and receive parameters that result in reliable transmission of data to other driver ICs 308b-308d. In some implementations, due to the difference in the physical and electrical properties of links connecting the controller 304 to each of the four driver ICs 308a-308d, the controller 304 may determine different power levels needed to communicate data reliably with different driver ICs 308a-308d. For example, the controller 304 may determine that the lowest power consumption needed to communicate data reliably with the first and the fourth driver ICs 308a and 308d is less than the lowest power consumption needed to communicate data reliably with the second and third driver ICs 308b and 308c. Thus, the controller 304, to communicate with the first and fourth driver ICs 308a and 308d, may operate at a power consumption level that is lower than the power consumption level used to communicating with the second and the third driver ICs 308b and 308c. This results in overall reduction in the power consumption of the display device 300 while maintaining reliable data communication between the controller 304 and the four driver ICs 308a-308d.

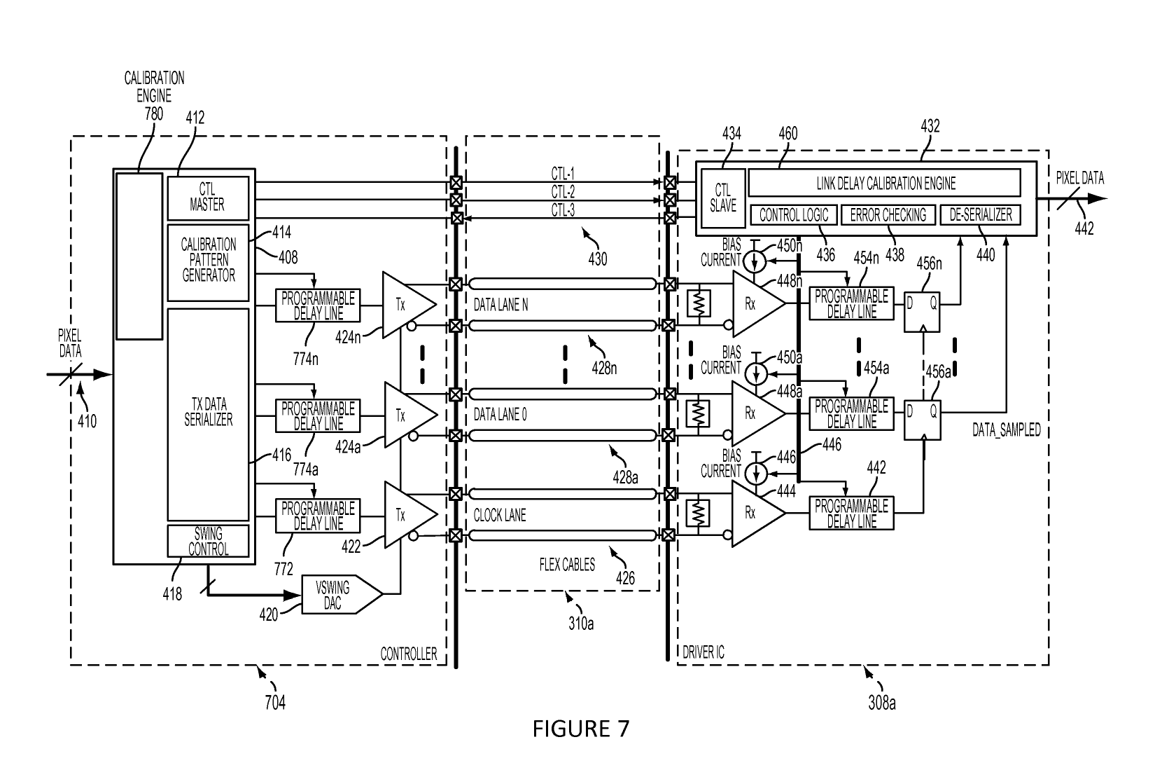

FIG. 7 shows another example block diagram 700 of a portion of another example display device 300 shown in FIG. 4. In particular, FIG. 7 shows a controller 704 connected to the first driver IC 308a via the first link 310a. The controller 704 can be utilized for implementing the controller 304 of the display device 300 shown in FIG. 4. Various components of the controller 704 are similar to the components of the controller 304 shown in FIG. 5, and are labeled with the same reference numerals. However, the controller 704 also can include programmable delay lines 772 and 774a-774n and a controller-side link delay calibration engine 780. The controller 704 also can execute the example process 500 shown in FIG. 6 for adaptively calibrating the display device shown in FIG. 5.

The programmable delay lines 772 and 774a-774n can be similar to the programmable delay lines 454a-454n included in the driver IC 308a. In that the programmable delay lines 772 and 774a-774n can introduce a programmable delay or a phase shift between their respective input signals and their respective output signals. The programmable delay line 772 can introduce a programmed delay in the clock signal transmitted over the clock lane 426, while each of the programmable delay lines 774a-774n can introduce a programmable delay in the data signals transmitted over the data lanes 0-N428a-428n. The delay introduced in the clock signal or the data signals can be used to compensate for the delay the clock and data signals may experience over the clock lanes and data lanes.

In some implementations, the controller 704, in response to receiving an indication of transmission data error from the driver IC 308a, can adjust the delays of the programmable delay lines 772 and 774a-774n in addition to adjusting the voltage swing of the transmission amplifiers (422 and 424a-424n) and instructing the driver IC 308a to adjust the bandwidth of the receiver amplifiers (444 and 448a-448n) and/or the delay parameters of the delay lines (442 and 454a-454n) at the output of the receiver amplifiers. Adjusting the delay of the transmitted signals at the controller allows additional control and in reducing transmission errors. In some implementations, the controller-side link delay calibration engine 780 can separately program the delays of each of the programmable delay lines 772 and 774a-774n.

In some implementations, the driver IC 308 may not include the programmable delay lines 442 and 454a-454n. In some such implementations, the desired phase shift between the data signals and the clock signals can be instead maintained solely by the programmable delay lines 772 and 774a-774n at the controller 704.

FIGS. 8A and 8B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 8A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus including:
a plurality of driver integrated circuits (ICs) configured to drive at least a portion of a display panel; and
a controller, communicably coupled to each of the plurality of drivers ICs for transmitting data and control signals to the plurality of driver ICs, the controller configured to independently adjust at least one of a transmission parameter of the controller and a receiver parameter of the plurality of driver ICs to reduce power consumption while maintaining data transmission quality.

2. The apparatus of claim 1, wherein the transmission parameter includes at least one of a magnitude of a voltage swing of a transmission amplifier of the controller and a transmission delay of data inputted to a transmission amplifier.

3. The apparatus of claim 1, wherein the receiver parameter includes at least one of a receiver bandwidth and a receiver sampling delay.

4. The apparatus of claim 3, wherein the controller is further configured to adjust the receiver bandwidth by adjusting bias currents provided to one or more receiving amplifiers.

5. The apparatus of claim 3, wherein the controller is further configured to adjust the receiver sampling delay by adjusting delays of programmable delay lines associated with one of the clock signal and one or more data and control signals.

6. The apparatus of claim 1, wherein the driver ICs are configured to evaluate data transmission errors in data received from the controller and to provide feedback on detected errors to the controller, and wherein the controller is further configured to further adjust at least one of the transmission parameter and the receiver parameter based on the feedback.

7. The apparatus of claim 1, further comprising:
a display;
a processor capable of communicating with the display, the processor being capable of processing image data; and
a memory device capable of communicating with the processor.

8. The apparatus of claim 1, further comprising:
a driver circuit capable of sending at least one signal to the display; and
a controller capable of sending at least a portion of the image data to the driver circuit.

9. The apparatus of claim 1, further comprising:
an image source module capable of sending the image data to the processor, wherein the image source module includes at least one of a receiver, transceiver, and transmitter.

10. The apparatus of claim 1, further comprising:
an input device capable of receiving input data and communicating the input data to the processor.

11. An apparatus comprising:
a controller configured to communicate data and control signals to a plurality of driver integrated circuits (ICs) capable of driving at least a portion of a display panel;
a communication quality determination means for determining the quality of communication between the controller and the driver ICs; and
communication parameter determination means for independently determining parameters of communications between the controller and each of respective driver ICs based on the quality of the communications between the controller and each respective driver IC as determined by the communication quality determination means.

12. The apparatus of claim 11, further including bandwidth adjustment means at each driver IC for adjusting bandwidths of receiving amplifiers of the respective driver ICs as determined by the communication parameter determination means.

13. The apparatus of claim 11, further including transmitter voltage adjustment means for adjusting a voltage swing of transmitting amplifiers at the controller as determined by the communication parameter determination means.

14. The apparatus of claim 11, further including transmitter timing adjustment means for adjusting delay of data provided to transmitting amplifiers at the controller as determined by the communication parameter determination means.

15. The apparatus of claim 11, further including timing adjustment means for adjusting data sampling delay of at least one of the plurality of driver ICs as determined by the communication parameter determination means.

16. A system comprising:
a processor capable of processing image data to produce processed image data; and
a display apparatus, communicably coupled to the processor, including:
a display panel including a plurality of light modulators for displaying an image;
a plurality of driver ICs, coupled to a display panel, capable of driving at least a portion of the display panel, each of the plurality of driver ICs including a plurality of receiving amplifiers for receiving data and control signals via a plurality of links; and
a driver controller communicably coupled to the processor and including a plurality of transmitters for transmitting data and control signals to the plurality of driver ICs over the plurality of links, the driver controller configured to:
use the processed image data received from the processor to generate the data and control signals transmitted to each of the plurality of driver ICs, and
independently adjust at least one of a transmission parameter of the plurality of transmitters and a receiver parameter of the plurality of receivers to reduce power consumption while maintaining transmission quality of data and control signals over the plurality of communication links.

17. The system of claim 16, wherein the transmission parameters include at least one of magnitude of voltage swings of one or more transmission amplifiers of the controller and a transmission delay of data inputted to one or more transmission amplifiers.

18. The system of claim 16, wherein the receiver parameters include at least one of receiver bandwidth and a receiver sampling delay.

19. The system of claim 16, wherein the driver ICs are capable of evaluating data transmission errors in data received from the controller and of providing feedback on detected errors to the controller, and wherein the controller is further configured to further adjust at least one of transmission parameters and receiver parameters based on the feedback

20. A method for maintaining data transmission quality between a display controller and a plurality of driver integrated circuits (ICs) configured to drive at least a portion of a display panel, comprising:
transmitting calibration data from the controller to the plurality of driver ICs;
receiving at the controller data error information from the plurality of driver ICs; and
adjusting receiver parameters of one of the plurality of driver ICs independently of receiver parameters of another of the plurality of driver ICs based on the received data error information.

21. The method of claim 20, wherein adjusting receiver parameters of one of the plurality of driver ICs independently of receiver parameters of another of the plurality of driver ICs based on the received data error information includes adjusting at least one of receiver bandwidth and receiver sampling delay of one of the plurality of driver ICs.

22. The method of claim 20, wherein the method further includes adjusting, based on the received data error information, at least one of magnitude of output voltage swing of and a delay of data inputted to a transmission amplifier used for transmitting data to the one of the plurality of driver ICs.
